(19) United States
(12) Patent Application Publication
(10) Pub. No.: US 2004/0015638 A1
(43) Pub. Date: Jan. 22, 2004

(54) Scalable modular server system

(76) Inventor: Bryn B. Forbes, Santa Clara, CA (US)

Correspondence Address: KENYON & KENYON, 1500 K Street, N.W., Suite 700, Washington, DC, 20005-1257, US

(21) Appl. No.: 10/199,005

(22) Filed: Jul. 22, 2002

(51) Int. Cl. G06F 13/00

(52) U.S. Cl. 710/316

(57) ABSTRACT

A server assembly is provided that includes a first server module and a second server module. The first server module may have a plurality of processors and the second server module may have a plurality of processors. A switch fabric module may dynamically couple the first server module to the second server module.

### FIELD

The present invention relates to the field of computer systems. More particularly, the present invention relates to a scalable modular server system.

### BACKGROUND

As technology has progressed, the processing capabilities of computer systems have increased dramatically. This increase has led to a dramatic increase in the types of software applications that can be executed on a computer system as well as an increase in the functionality of these software applications.

Technological advancements have led the way for multiple computer systems, each executing software applications, to be easily connected together via a network. Computer networks often include a large number of computers, of differing types and capabilities, interconnected through various network routing systems, also of differing types and capabilities.

Conventional servers typically are self-contained units that include their own functionality such as disk drive systems, cooling systems, input/output (I/O) subsystems and power subsystems. In the past, multiple servers may be utilized where each server is housed within its own independent cabinet (or housing assembly). However, with the decreased size of servers, multiple servers may be provided within a smaller sized cabinet or be distributed over a large geographic area.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 is an example data network according to one arrangement;

FIG. 2 is an example server assembly according to one arrangement;

FIG. 3 is an example server assembly according to one arrangement;

FIG. 4 is an example server assembly according to one arrangement;

FIG. 5 is a diagram of a server system according to one arrangement; and

FIG. 6 is a block diagram of a server system according to an example embodiment of the present invention.

### DETAILED DESCRIPTION

In the following detailed description, like reference numerals and characters may be used to designate identical, corresponding or similar components in differing figure drawings. Further, in the detailed description to follow, example values may be given, although the present invention is not limited to the same. Arrangements and embodiments may be shown in block diagram form in order to avoid obscuring the invention, and also in view of the fact that specifics with respect to implementation of such block diagram arrangements and embodiments may be highly dependent upon the platform within which the present invention is to be implemented. That is, such specifics should be well within the purview of one skilled in the art. Where specific details are set forth in order to describe example embodiments of the invention, it should be apparent to one skilled in the art that the invention can be practiced without, or with variation of, these specific details. Finally, it should be apparent that differing combinations of hard-wired circuitry and software instructions may be used to implement embodiments of the present invention. That is, embodiments of the present invention are not limited to any specific combination of hardware and software.

Embodiments of the present invention are applicable for use with different types of data networks and clusters designed to link together computers, servers, peripherals, storage devices, and/or communication devices for communications. Examples of such data networks may include a local area network (LAN), a wide area network (WAN), a campus area network (CAN), a metropolitan area network (MAN), a global area network (GAN), a storage area network and a system area network (SAN), including data networks using Next Generation I/O (NGIO), Future I/O (FIO), Infiniband and Server Net and those networks that may become available as computer technology develops in the future. LAN systems may include Ethernet, FDDI (Fibre Distributed Data Interface) Token Ring LAN, Asynchronous Transfer Mode (ATM) LAN, Fibre Channel, and Wireless LAN. Embodiments may hereafter be described with respect to an Infiniband architecture although other architectures are also within the scope of the present invention.

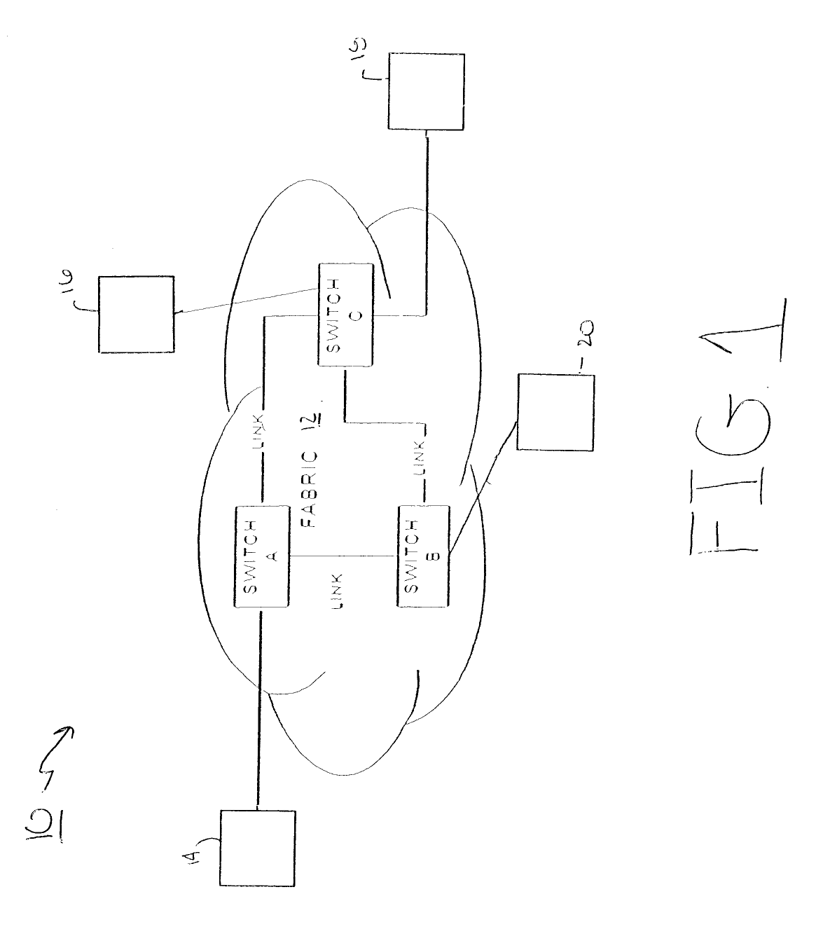

FIG. 1 shows an example data network 10 having several interconnected endpoints (nodes) for data communications according to one arrangement. Other arrangements are also possible. As shown in FIG. 1, the data network 10 may include an interconnection fabric (hereafter referred to as “switched fabric”) 12 of one or more switches (or routers) A, B and C and corresponding physical links, and several endpoints (nodes) that may correspond to one or more servers 14, 16, 18 and 20 (or server assemblies).

The servers may be organized into groups known as clusters. A cluster is a group of one or more hosts, I/O units (each I/O unit including one or more I/O controllers) and switches that are linked together by an interconnection fabric to operate as a single system to deliver high performance, low latency, and high reliability. The servers 14, 16, 18 and 20 may be interconnected via the switched fabric 12.

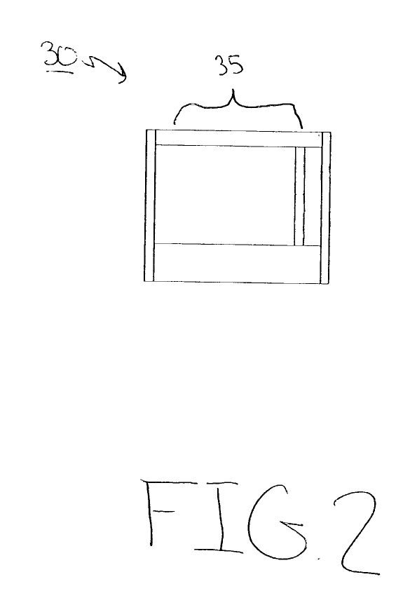

FIG. 2 is example server assembly according to one arrangement. Other arrangements are possible. More specifically, FIG. 2 shows a server assembly (or server housing) 30 having a plurality of server blades 35. The server assembly 30 may be a rack-mountable chassis and may accommodate a plurality of independent server blades 35. For example, the server assembly shown in FIG. 2 houses sixteen server blades. Other numbers of server blades are also possible. Although not specifically shown in FIG. 2, the server assembly 30 may include a built-in system cooling and temperature monitoring device(s). The server blades 35 may be hot-pluggable for all the plug-in components. Each of the server blades 35 may be a single board computer that, when paired with companion rear panel media blades, may form independent server systems. That is, each server blade may include a processor, RAM, an L2 cache, an integrated disk drive controller, and BIOS, for example. Various switches, indicators and connectors may also be provided on each server blade. Though not shown in FIG. 2, the server assembly 30 may include rear mounted media blades that are installed inline between server blades. Together, the server blades and the companion media blades may form independent server systems. Each media blade may contain hard disk drives. Power sequencing circuitry on the media blades may allow a gradual startup of the drives in a system to avoid power overload during system initialization. Other components and/or combinations may exist on the server blades or media blades and within the server assembly. For example, a hard drive may be on the server blade, multiple server blades may share a storage blade or the storage may be external.

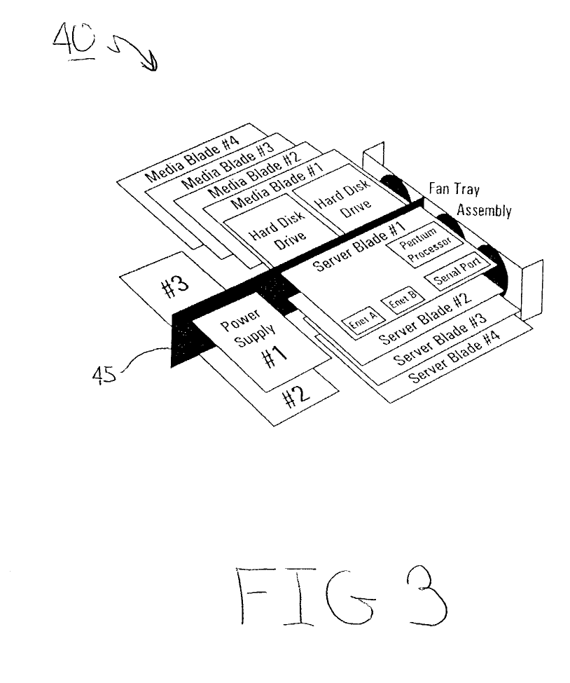

FIG. 3 shows a server assembly 40 according to one example arrangement. Other arrangements are also possible. More specifically, the server assembly 40 includes Server Blade #1, Server Blade #2, Sever Blade #3 and Server Blade #4 mounted on one side of a chassis 45, and Media Blade #1, Media Blade #2, Media Blade #3 and Media Blade #4 mounted on the opposite side of the chassis 45. The chassis 45 may also support Power Supplies #1, #2 and #3. Each server blade may include Ethernet ports, a processor and a serial port, for example. Each media blade may include two hard disk drives, for example. Other configurations for the server blades, media blades and server assemblies are also possible.

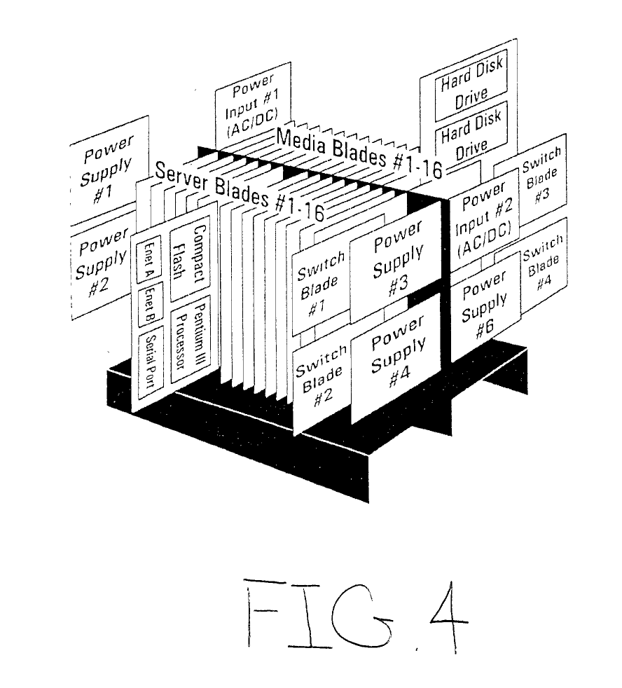

FIG. 4 shows a server assembly according to another example arrangement. Other arrangements are also possible. The server assembly shown in FIG. 4 includes sixteen server blades and sixteen media blades mounted on opposite sides of a chassis.

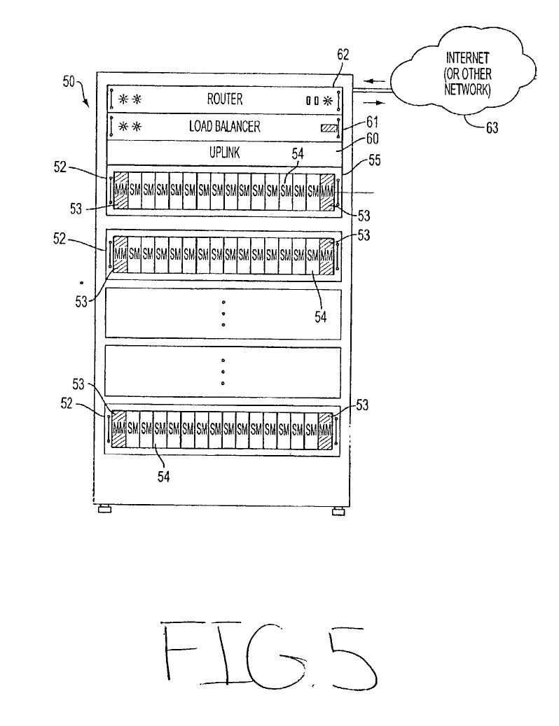

FIG. 5 shows a rack mounted server system 50 according to one arrangement. Other arrangements are also possible. The rack carries a plurality of integrated server system units 52 each having one or more management modules (MM) 53 and one or more server modules (SM) 54. Each server module may provide a fully independent server. Each server may include a processor and memory, mass storage device such as a hard disk drive, and input/output ports. In this example, each high chassis 55 has sixteen slots each of which may contain a PC-board mounted server module 54 or management module 53. The chassis 55 may also provide one or more power supplies and one or more cooling fan banks. These elements may be coupled for communication by switches and a backplane as will be described.

The chassis unit 55 may be coupled together to form a larger system and these server units may share a gigabit uplink 60, a load balancer 61, and a router 62 to connect to a network such as the Internet 63.

Embodiments of the present invention may provide a server assembly that includes a first server module and a second server module. The first server module may have a plurality of processors and the second server module may have a plurality of processors. A switch fabric module may dynamically couple the first server module to the second server module. Other numbers of server modules are also within the scope of the present invention.

Embodiments of the present invention may also provide a switch assembly that includes the capability to dynamically connect to server assemblies and act as a single computing or storage device. The server assemblies may be coupled together when demand arises and/or may be separated to perform different tasks.

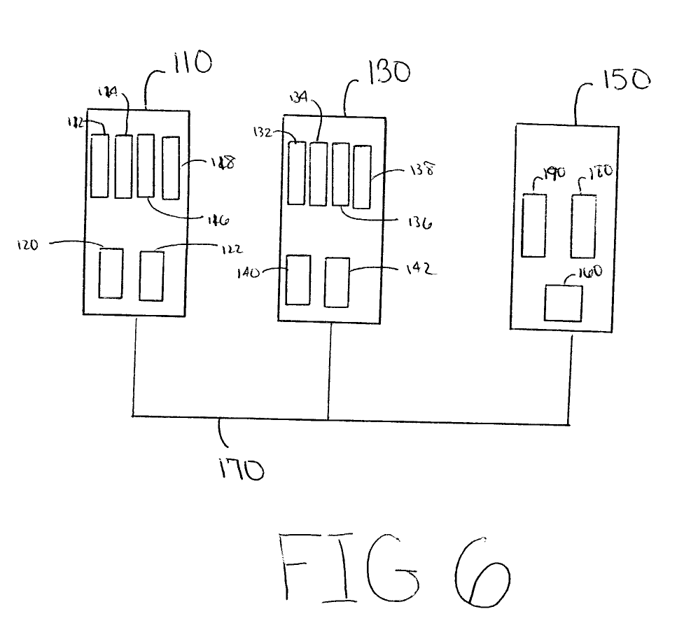

FIG. 6 shows how server modules may be coupled together according to an example embodiment of the present invention. Other embodiments and configurations are also within the scope of the present invention. While the following discussion relates to server modules, embodiments of the present invention are also applicable to connecting blades or modules. FIG. 6 shows a first server module 110, a second server module 130 and a switch fabric module 150. For ease of illustration, other server modules are not shown in this figure. The first server module 110 may be coupled to the switch fabric module 150 by a backplane 170 and the second server module 130 may be coupled to the switch fabric module 150 by the backplane 170. The modules may be hot-swappable to allow the units to be plugged in and removed from a server housing such as those shown in the previous figures. The switch fabric module 150 may allow for a dynamically reconfigurable tightly coupled microprocessor system.

As shown, the first server module 110 may include four processors 112, 114, 116 and 118 as well as a chipset 120 and memory 122. The second server module 130 may include four processors 132, 134, 136 and 138 as well as a chipset 140 and memory 142. Other components and number of components may also be provided.

The switch fabric module 150 may provide a multi-connection switching fabric to link the server modules 110 and 130 and allow for dynamic reconfigurability. For example, the switch fabric module 150 may have a plurality of switches 160 inside that establishes connections between different modules (or blades or nodes). The switch fabric module 150 may include a processor 180 and appropriate software 190 to scale the processing and I/O capability of the server modules by connecting together multiple processor nodes into one effective server (or server module). This may be implemented by utilizing modular server blades having connections that act as nodes in an n-way multiprocessing machine. More specifically, the processor 180 and the software 190 may operate the switches 160 to appropriately connect (or disconnect) the different modules.

The chipset 120 of the first server module 110 and the chipset 140 of the second server module 130 may each include a scalability port for connecting processor nodes in a shared memory microprocessor machine (SMP) fashion. The switch fabric module 150 may include scalability switches (shown as the switches 160) that connect the scalability ports of the first server module 110 and the second server module 130 and couple the ports together so as to allow the system including multiple distinct parts to act as a single entity, and disconnects to allow hot swapping of the nodes (formed by the various server modules).

The switch fabric module 150 may connect the different processor and chipset nodes (shown as the first server module 110 and the second server module 130), and act as a scalability switch to dynamically connect different subsets of all the nodes to form a larger subset. The software 190 may interface to hardware (such as the switches 160) that performs the connections. This type of network may be considered a circuit-switched network in which the server modules 110 and 130 (and more specifically the chipsets 120 and 140) would have this uplink.

Embodiments of the present invention allow scaling of servers as more capacity is needed while minimizing the number of operating system instances required (such as for hot-swapping). This allows users to add modules as demand increases. Embodiments of the present invention may connect processors together to form a single multi-processor system.

Embodiments of the present invention may provide a switch assembly that includes the capability to connect server assemblies to an entity that acts as a single computing or storage device dynamically. The servers may also be connected together when demand arises or may be separated to perform different tasks. Embodiments of the present invention may also provide software and firmware that would the scalability port to be dynamically connected and disconnected.

While embodiments of the present invention have been described with respect to the first server assembly including a server blade coupled to a backplane, other configurations are also within the scope of the present invention. For example, in an Infiniband configuration, information may be transmitted over cables.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc.

Further, the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc..

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A server assembly comprising:
a first server module;
a second server module; and
a switch fabric module to dynamically couple said first server module to said second module.

2. The server assembly of claim 1, wherein said switch fabric module comprises switch components and a mechanism to operate said switch components.

3. The server assembly of claim 2, wherein said mechanism comprises a processor and software.

4. The server assembly of claim 1, wherein said first server module comprises a chipset and at least one processor.

5. The server assembly of claim 4, wherein said chipset includes a scalability port.

6. The server assembly of claim 5, wherein said switch fabric module dynamically connects scalability ports of different server modules.

7. The server assembly of claim 1, wherein said switch fabric module allows additional server modules to be added.

8. The server assembly of claim 1, wherein said first server assembly comprises a server blade coupled to a backplane of said server assembly.

9. A device comprising:
a first blade having at least a first processor;
a second blade having at least a second processor; and
a switch fabric module having logic and switch components to dynamically couple said first blade to said second blade.

10. The device of claim 9, wherein said first blade comprises a chipset.

11. The device of claim 10, wherein said chipset includes a scalability port.

12. The device of claim 11, wherein said switch fabric module dynamically connects said scalability port of said first blade to a scalability port of said second blade.

13. The device of claim 9, wherein said switch fabric module allows additional server modules to be added.

14. A server assembly comprising:
a first server module;
a second server module; and
means for dynamically coupling said first server module to said second server module.

15. The server assembly of claim 14, wherein said means for dynamically coupling comprises switch components and a mechanism to operate said switch components.

16. The server assembly of claim 15, wherein said mechanism comprises a processor and software.

17. A method comprising:
operating a first processor on a first server blade;
operating a second processor on a second server blade; and
dynamically coupling said first server blade to said second server blade.

18. The method of claim 17, wherein dynamically coupling said first server blade to said second server blade comprises operating at least a switch component on a switch fabric module.

19. The method of claim 18, wherein said first server module comprises a chipset and at least one processor.

20. The method of claim 19, wherein said chipset includes a scalability port, and dynamically coupling further comprises connecting said scalability port of said chipset with a scalability port on said second server blade.
